(19) United States
(12) Patent Application Publication
(10) Pub. No.: US 2025/0077764 A1
(43) Pub. Date: Mar. 6, 2025

(54) METHOD AND APPARATUS FOR DISPLAYING ARTIFICIAL INTELLIGENCE CONTENT

(71) Applicant: NAVER CORPORATION, Seongnam-si (KR)

(72) Inventors: Yong Hwan LEE, Seongnam-si (KR); Daeyoung LEE, Seongnam-si (KR); Musokhon MUKAYUMKHONOV, Seongnam-si (KR); Sungbae KIM, Seongnam-si (KR); Young Ja JEON, Seongnam-si (KR); Hyiesoo JEONG, Seongnam-si (KR); Yong Uk KIM, Seongnam-si (KR); Kyungil PARK, Seongnam-si (KR)

(21) Appl. No.: 18/819,206

(22) Filed: Aug. 29, 2024

(30) Foreign Application Priority Data
Sep. 6, 2023 (KR) 10-2023-0118644

(51) Int. Cl. G06F 40/166; G06T 11/60

(52) U.S. Cl. CPC G06F 40/166; G06T 11/60; G06T 2211/441

(57) ABSTRACT

A method for displaying an artificial intelligence (AI) content, executed by one or more processors, includes receiving an AI-generated content; outputting the AI-generated content on a display; receiving, from a user, a user request to modify a first part of the AI-generated content; modifying the first part to a user-generated content based on the user request and outputting a second part of the AI-generated content on the display together with a first visual effect.

### CROSS-REFERENCE TO RELATED APPLICATION

This application claims priority to Korean Patent Application No. 10-2023-0118644, filed in the Korean Intellectual Property Office on Sep. 6, 2023, the entire contents of which are hereby incorporated by reference.

### BACKGROUND OF THE INVENTION

### Field of Invention

The present disclosure relates to a method and an apparatus for displaying artificial intelligence (AI) content, and more specifically, to a method and an apparatus for distinguishing AI-generated content from user-generated content and displaying the same.

### Description of Related Art

In recent years, so-called generative AI models, which use artificial intelligence (AI) to generate content in various formats such as text, images, and video, have been actively developed and their use is rapidly increasing. Users of the generative AI model can modify and delete some of the generated content or add new content to generate final content in relatively short time.

However, there is a shortcoming. That is, once the user changes the content generated in the generative AI model, it is difficult to determine whether a specific part of the content is generated by the AI or by the user. For example, in order to determine if certain part of the content is generated by the AI or by the user, if original AI-generated content is available, the user has to compare the original content with the changed content piece by piece, and if there is no original AI-generated content, it is very difficult to identify who or what generated the content of each part.

Therefore, there is a need for a new method that can clarify the distinction between AI-generated content and user-generated content, thereby improving work efficiency when generating content.

### BRIEF SUMMARY OF THE INVENTION

In order to solve one or more problems (e.g., the problems described above and/or other problems not explicitly described herein), the present disclosure provides a method, a non-transitory computer-readable recording medium storing instructions, and an apparatus (system) for displaying AI content.

The present disclosure may be implemented in a variety of ways, including methods, systems (apparatus) or non-transitory computer readable storage media storing instructions.

A method for displaying an artificial intelligence (AI) content is provided, which may be executed by one or more processors, and include receiving an AI-generated content, outputting the AI-generated content on a display, receiving, from a user, a user request to modify a first part of the AI-generated content, modifying the first part to a user-generated content based on the user request and outputting a second part of the AI-generated content, which is a different part than the first part, on the display together with a first visual effect.

An apparatus is provided, which may include a communication module, a display, a memory and one or more processors connected to the memory and configured to execute one or more computer-readable programs included in the memory, wherein the one or more programs may include instructions for receiving an AI-generated content, outputting the AI-generated content on the display, receiving, from a user, a user request to modify a first part of the AI-generated content, modifying the first part to a user-generated content based on the user request, and outputting a second part of the AI-generated content, which is a different part than the first part, on the display together with a first visual effect.

A label dynamic control method is provided, which may be executed by one or more processors, and include allocating a first label to an AI-generated content, receiving a user request to modify a first part of the AI-generated content, modifying the first part to a user-generated content based on the user request and allocating a second label to the user-generated content.

There is provided a non-transitory computer-readable recording medium storing instructions for executing on a computer the method for displaying an artificial intelligence (AI) content.

According to some aspects of the present disclosure, by clarifying the distinction between AI-generated content and user-generated content, work efficiency when generating content can be improved.

According to some aspects of the present disclosure, it is possible to clearly distinguish each part of the content generated by multiple models and/or changed by multiple users according to the subjects that generated and/or changed the content.

The effects of the present disclosure are not limited to the effects described above, and other effects not mentioned will be able to be clearly understood by those of ordinary skill in the art from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 is a diagram illustrating an example in which a changed content is generated from an artificial intelligence (AI) generated content and displayed;

FIG. 2 schematically illustrates a configuration in which an information processing system is communicatively connected to a plurality of user terminals to provide an AI content display service;

FIG. 3 is a block diagram of an internal configuration of a user terminal and the information processing system;

FIG. 4 is a diagram illustrating an example of a structured document including an AI-generated content and label information allocated to the AI-generated content;

FIG. 5 is a diagram illustrating an example of objects in a structured document;

FIG. 6 is a diagram illustrating an example in which labels of content items are modified in response to a specific part of an AI-generated content being modified to a user-generated content;

FIG. 7 is a diagram illustrating an example in which labels are allocated after a content item is divided in response to a specific part that is a part of the content item being modified to a user-generated content;

FIG. 8 is a diagram illustrating subjects that allocate labels;

FIG. 9 is a flowchart provided to explain a method for displaying an AI content; and

FIG. 10 is a flowchart illustrating a label dynamic control method.

### DETAILED DESCRIPTION OF THE INVENTION

Hereinafter, example details for the practice of the present disclosure will be described in detail with reference to the accompanying drawings. However, in the following description, detailed descriptions of well-known functions or configurations will be omitted if it may make the subject matter of the present disclosure unclear.

In the accompanying drawings, the same or corresponding components are assigned the same reference numerals. In addition, in the following description of various examples, duplicate descriptions of the same or corresponding components may be omitted.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the described meaning of the terms and the overall content of the present disclosure.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to be executed in one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

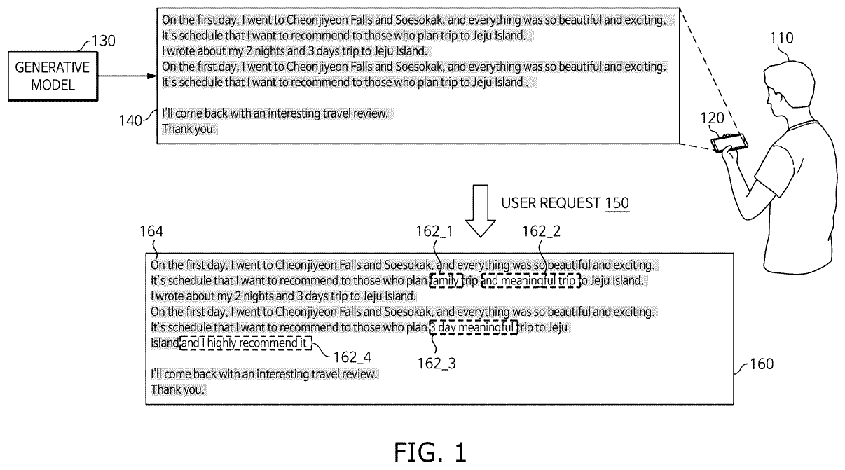

FIG. 1 is a diagram illustrating an example in which a changed content 160 is generated from an artificial intelligence (AI) generated content 140 and displayed. The AI-generated content 140 generated by a generative model 130 may be output on a display of a user terminal 120 according to a user request. The generative model 130 may be stored in an external device (e.g., a server) different from the user terminal 120, and may generate the AI-generated content 140 upon receiving a request from the user terminal 120. Alternatively, the generative model 130 may be stored in the user terminal 120.

In response to a user (i.e., a human) 110 inputting a user request 150 to modify part of the AI-generated content 140 into the user terminal 120, the changed content 160 may be generated. For example, the user 110 may input the user request 150 to add, modify, and/or delete certain content from the AI-generated content 140, and based on the user request 150, the changed content 160 may be generated from the AI-generated content 140 by adding, modifying, and/or deleting the certain content. That is, the changed content 160 may include a part of the previously generated AI-generated content 140, and a user-generated content added and/or modified by the user 110.

If the changed content 160 is output on the display of the user terminal 120, user-generated parts 162_1, 162_2, 162_3, and 162_4 added to and/or modified from the AI-generated content 140 may be displayed and distinguished from an AI-generated part 164 (that may be treated as background text). Only one of the user-generated parts 162_1, 162_2, 162_3, and 162_4 and the AI-generated part 164 output on the display may be displayed with visual effect. Alternatively, the user-generated parts 162_1, 162_2, 162_3, and 162_4 and the AI-generated part 164 may be output on the display with different visual effects, respectively. FIG. 1 illustrates that the user-generated part 162 and the AI-generated part 164 are distinguished from each other by setting the AI-generated part 164 as the background text, but the type of visual effect is not limited thereto. For example, the user-generated part 162 and the AI-generated part 164 may be displayed and distinguished from each other using various kinds of visual effects such as font style, color, size, background, thickness, shadow effect, highlighting, etc.

Additionally, content deleted by the user from the AI-generated content 140 may also be output on the display. For example, in response to the user 110 deleting a phrase “thank you” from the AI-generated content 140 of FIG. 1, the background text color of the phrase “thank you” may be removed, and a visual effect (e.g., strikethrough) indicating the content having been deleted may be additionally displayed as in the user-generated part 162.

Labels may be allocated differently to the AI-generated content and the user-generated content such that the user-generated part 162 and the AI-generated part 164 may be displayed and distinguished from each other. In this case, by referring to the label allocated to each content item, the user terminal 120 may determine whether to apply the visual effect and the visual effect to be applied and output the result on the display. For example, a first label may be allocated to the user-generated parts 162_1, 162_2, 162_3, and 162_4, and a second label may be allocated to the AI-generated part 164. In this case, as illustrated in FIG. 1, the user-generated part 162 and the AI-generated part 164 may be output to be distinguished from each other on the display.

Although FIG. 1 illustrates that the AI-generated content 140 is text content, aspects are not limited thereto. For example, the AI-generated content 140 may include any type of content (non-textual content) such as images, voices, and videos. For example, if the AI-generated content 140 is an image, a plurality of components (e.g., objects included in the image, effects, colors, textures, depth of field, etc. in the image) forming the image may be distinguished from each other through a cluster analysis process, etc. at the time of image generation by the generative model 130 or after the generation of the AI-generated content 140. If the user adds/modifies/deletes a specific component of the image, the AI-generated component and the user-generated component may be displayed and distinguished from each other through visual effects, etc. For example, a bokeh effect may be applied only to an area in which the AI-generated component in the image is displayed. Alternatively, a text description may be provided for each of the AI-generated component and the user-generated component in the image, and the AI-generated component and the user-generated component may be distinguished from each other using a difference in the visual effect of the text within the text description.

In another example, if the AI-generated content 140 is an image, for the individual frames forming the image, a plurality of components may be distinguished from each other in the same manner as when the AI-generated content 140 is an image as described above, and subjects that generated each of the plurality of frames may be distinguished from each other by using a difference in visual effects for each of the plurality of frames.

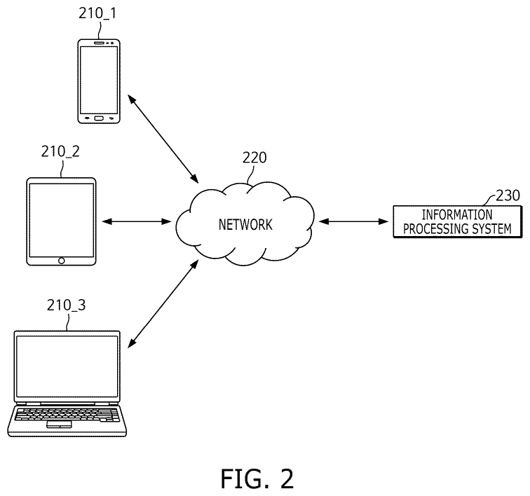

FIG. 2 schematically illustrates a configuration in which an information processing system 230 is communicatively connected to a plurality of user terminals 210_1, 210_2, and 210_3 to provide an AI content display service. The information processing system 230 may include a system(s) capable of providing an AI content display service and/or a label dynamic control service. The information processing system 230 may include one or more server devices and/or databases, or one or more distributed computing devices and/or distributed databases based on cloud computing services, which can store, provide and execute computer-executable programs (e.g., downloadable applications) and data related to an AI content display service and/or a label dynamic control service. For example, the information processing system 230 may include separate systems (e.g., servers) for providing the AI content display service.

The AI content display service, etc. provided by the information processing system 230 may be provided to the user through an AI content display application, a web browser application, etc. installed in each of the plurality of user terminals 210_1, 210_2, and 210_3.

The plurality of user terminals 210_1, 210_2, and 210_3 may communicate with the information processing system 230 through a network 220. The network 220 may be configured to enable communication between the plurality of user terminals 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, etc.) that may be included in the network 220 as well as short-range wireless communication between the user terminals 210_1, 210_2, and 210_3.

For example, the plurality of user terminals 210_1, 210_2, and 210_3 may transmit instructions associated with a request to generate AI content to the information processing system 230 through the network 220 and a user request to add/modify/delete specific content from the AI-generated content, and the information processing system 230 may receive the instructions.

In FIG. 2, a mobile phone terminal 210_1, a tablet terminal 210_2, and a PC terminal 210_3 are illustrated as the examples of the user terminals, but aspects are not limited thereto, and the user terminals 210_1, 210_2, and 210_3 may be any computing device that is capable of wired and/or wireless communication and that can be installed with the AI content display application, etc. and execute the same. For example, the user terminals may include smartphone, mobile phone, navigation system, computer, notebook computer, digital broadcasting terminal, Personal Digital Assistants (PDA), Portable Multimedia Player (PMP), tablet PC, game console, wearable device, Internet of things (IoT) device, virtual reality (VR) device, augmented reality (AR) device, etc. In addition, while FIG. 2 illustrates that three user terminals 210_1, 210_2, and 210_3 are in communication with the information processing system 230 through the network 220, aspects are not limited thereto, and a different number of user terminals may be configured to be in communication with the information processing system 230 through the network 220.

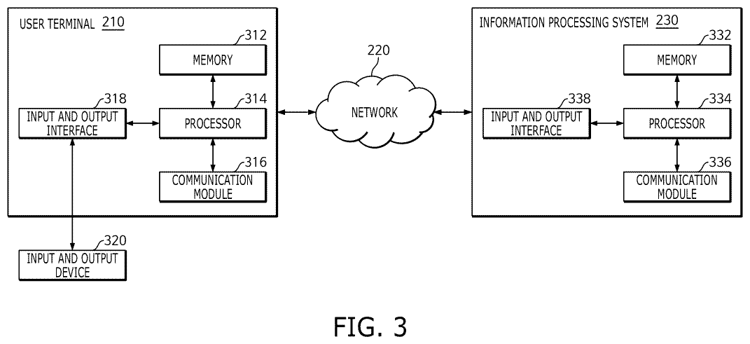

FIG. 3 is a block diagram of an internal configuration of a user terminal 210 and the information processing system 230. The user terminal 210 may refer to any computing device that is capable of executing the AI content display application, etc. and also capable of wired and wireless communication, and may include the mobile phone terminal 210_1, the tablet terminal 210_2, and the PC terminal 210_3 of FIG. 2, for example. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information, data, etc. through the network 220 using respective communication modules 316 and 336. In addition, an input and output device 320 may be configured to input information, data, etc. to the user terminal 210, or output information, data, etc. generated from the user terminal 210 through the input and output interface 318.

The memories 312 and 332 may include any non-transitory computer-readable recording medium. The memories 312 and 332 may include a permanent mass storage device such as read only memory (ROM), disk drive, solid state drive (SSD), flash memory, etc. As another example, a non-destructive mass storage device such as ROM, SSD, flash memory, disk drive, etc. may be included in the user terminal 210 or the information processing system 230 as a separate permanent storage device that is distinct from the memory. In addition, the operating system and at least one program code (e.g., code for AI content display services and/or applications associated with label dynamic control, etc.) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a DVD/CD-ROM drive, a memory card, etc., for example. As another example, the software components may be loaded into the memories 312 and 332 through the communication modules 316 and 336 rather than from the computer-readable recording medium. For example, at least one program may be loaded into the memories 312 and 332 based on a computer program (e.g., an application associated with AI content display service, etc.) installed by files provided through the network 220 by developers or a file distribution system that distributes application installation files.

The processors 314 and 334 may be configured to process the instructions of the computer program by performing basic arithmetic, logic, and input and output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210, the information processing system 230, etc. to communicate with another user terminal or another system (e.g., a separate cloud system, etc.). For example, a request or data (e.g., content add/modify/delete request or data, etc.) generated by the processor 314 of the user terminal 210 according to the program code stored in the recording device such as the memory 312 may be transmitted to the information processing system 230 through the network 220 under the control of the communication module 316. Conversely, a control signal or command provided under the control of the processor 334 of the information processing system 230 may be received by the user terminal 210 through the communication module 316 of the user terminal 210 through the communication module 336 and the network 220.

The input and output interface 318 may be a means for interfacing with the input and output device 320. As an example, an input device may include a device such as a camera including an audio sensor and/or an image sensor, a keyboard, a microphone, a mouse, etc., and an output device may include a device such as a display, a speaker, a haptic feedback device, etc. As another example, the input and output interface 318 may be a means for interfacing with a device such as a touch screen, etc. that incorporates a configuration or function for performing inputting and outputting. While FIG. 3 illustrates that the input and output device 320 is not included in the user terminal 210, aspects are not limited thereto, and the input and output device 320 may be configured as one device with the user terminal 210. In addition, the input and output interface 338 of the information processing system 230 may be a unit for interfacing with a device (not illustrated) for inputting or outputting that may be connected to, or included in, the information processing system 230. While FIG. 3 illustrates the input and output interfaces 318 and 338 as the components configured separately from the processors 314 and 334, aspects are not limited thereto, and the input and output interfaces 318 and 338 may be configured to be included in the processors 314 and 334.

The user terminal 210 and the information processing system 230 may include more components than those illustrated in FIG. 3. For example, user terminal 210 may be implemented to include at least a part of the input and output device 320 described above. In addition, the user terminal 210 may further include another component such as a transceiver, a global positioning system (GPS) module, a camera, various sensors, a database, etc. If the user terminal 210 is a smartphone, it may further include components generally included in smartphones, such as an acceleration sensor, a gyro sensor, a microphone module, a camera module, various physical buttons, buttons using a touch panel, input and output ports, a vibrator for vibration, etc.

The processor 314 of the user terminal 210 may be configured to operate an AI content display application or a web browser application that provides an AI content display service. In this case, a program code associated with that application may be loaded into the memory 312 of the user terminal 210. While the application is running, the processor 314 of the user terminal 210 may receive information and/or data provided from the input and output device 320 through the input and output interface 318 or receive information and/or data from the information processing system 230 through the communication module 316, and process the received information and/or data and store it in the memory 312. In addition, such information and/or data may be provided to the information processing system 230 through the communication module 316.

While the AI content display application is running, the processor 314 may receive voice data, text, image, video, etc. input or selected through the input device such as a camera, a microphone, etc. that includes a touch screen, a keyboard, an audio sensor and/or an image sensor connected to the input and output interface 318, and store the received voice data, text, image, and/or video, etc. in the memory 312, or provide it to the information processing system 230 through the communication module 316 and the network 220. The processor 314 may receive a user input through an input device and provide data and request corresponding to the received user input to the information processing system 230 through the network 220 and the communication module 316.

The processor 314 of the user terminal 210 may transmit and output the information and/or data to the input and output device 320 through the input and output interface 318. For example, the processor 314 of the user terminal 210 may output the processed information and/or data through the output device 320 such as a device capable of outputting a display (e.g., a touch screen, a display, etc.), a device capable of outputting a voice (e.g., speaker), etc.

The processor 334 of the information processing system 230 may be configured to manage, process, and/or store information, data, etc. received from a plurality of user terminals 210, a plurality of external systems, etc. The information and/or data processed by the processor 334 may be provided to the user terminals 210 through the communication module 336 and the network 220.

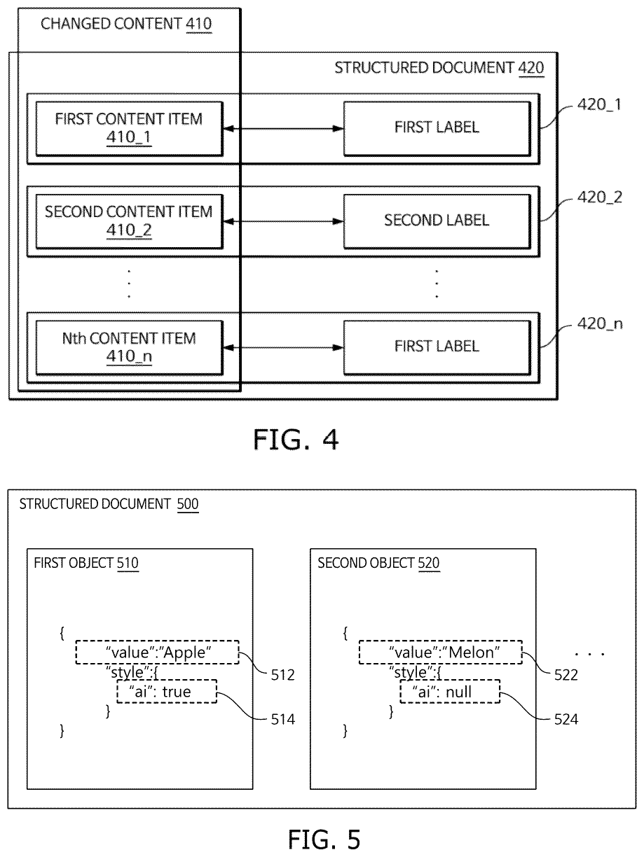

FIG. 4 is a diagram illustrating an example of a structured document 420 including changed content 410 and label information allocated to the changed content. The changed content 410 may be divided into a plurality of content items 410_1 to 410_n and stored in the structured document 420. In this case, a label may be allocated to each of the plurality of content items 410_1 to 410_n. The content item and the label as a pair may be stored as an object in the structured document 420. As illustrated in the drawing, the structured document 420 may include a plurality of objects 420_1 to 420_n.

The changed content 410 may be divided into the plurality of content items 410_1 to 410_n according to a predetermined unit. The predetermined unit may be one of a morpheme unit, a letter unit, a word unit, a sentence unit, and a paragraph unit. For example, if the changed content 410, that is, text “I'll come back with an interesting travel review” is divided into word units, each of the plurality of content items 410_1 to 410_n may be “I'll come back with,” “an interesting,” “travel,” “review.”

The structured document 420 may include the plurality of objects 420_1 to 420_n corresponding to the plurality of content items 410_1 to 410_n. Each of the plurality of objects 420_1 to 420_n may include each of the plurality of content items 410_1 to 410_n and corresponding label information. The structured document 420 may be written in various formats (e.g., JSON format).

The labels may be allocated based on the subjects (i.e., an AI or a user) that generated each of the plurality of content items 410_1 to 410_n. For example, a first label (e.g., true) may be automatically allocated to an AI-generated content item, and the first label may be automatically deleted or a second label (e.g., null) may be automatically allocated to a user-generated content item. In another example, the label may be allocated only to one of the AI-generated content item and the user-generated content item, and the label may not be allocated to the other.

As a result, the subjects that generated each of the plurality of content items 410_1 to 410_n may be distinguished by referring to the labels allocated to the plurality of content items 410_1 to 410_n. For example, in response to determining that the first label is allocated to the first content item 410_1 that is an AI-generated content, the first content item 410_1 may be output with the first visual effect on the display. On the other hand, in response to determining that the second label is allocated to the second content item 410_2 that is a user-generated content, the second content item 410_2 may be output on the display without the first visual effect, or may be output on the display with a second visual effect different from the first visual effect.

Although FIG. 4 illustrates that two types of labels (the first and second labels) are allocated to the plurality of content items 410_1 to 410_n, aspects are not limited thereto. For example, if the content is generated by a plurality of generative models, any one of a plurality of labels corresponding to the plurality of generative models may be allocated to the generated content part based on the subjects that generated the content. In another example, if a plurality of users changed the content, based on the subjects that changed the content, any one of a plurality of labels corresponding to the plurality of users may be allocated to the changed content part. Through this, it is possible to clearly distinguish each part of the content generated by multiple models and/or changed by multiple users according to the subjects that generated and/or changed the content.

FIG. 5 is a diagram illustrating an example of objects 510 and 520 in a structured document 500. Each of the objects 510 and 520 included in the structured document 500 may be expressed as a set of key-value pairs. The objects 510 and 520 may include key-value pairs 512 and 522 associated with the content item and key-value pairs 514 and 524 associated with the labels allocated to the content item. For example, a label value “true” (corresponding to the first label in FIG. 4) for the key “ai” may indicate that the content item that is a value for a key “value” in the corresponding object is an AI-generated content. On the other hand, a label value “null” (corresponding to the second label in FIG. 4) for the key “ai” may indicate that the content item that is a value for the key “value” in the corresponding object is a user-generated content. In this context, a content item “Apple” may be determined to correspond to the AI-generated content based on the key-value pair 512 and 514 of the first object 510 in the structured document 500 illustrated in FIG. 5, and a content item “Melon” may be determined to correspond to the user-generated content based on the key-value pair 522 and 524 of the second object 520.

The key names, label names, etc. in the objects 510 and 520 illustrated in FIG. 5 are examples, and aspect are not limited thereto. For example, instead of the key “ai” indicating whether or not the content is AI-generated content, a key “user” may be used to indicate whether or not the content is user-generated content, in which case a “user”:null key-value pair may be included in the first object 510 instead of the “ai”:true key-value pair 514 of the first object 510. In addition, instead of allocating a null label, the label or the key-value pair may be deleted. In addition, the objects 510 and 520 may further include key-value pairs (e.g., key-value pairs associated with the order of displaying content items, etc.) different from those illustrated.

Additionally, if the AI-generated content and/or the user-generated content includes non-textual content such as images, the non-textual content or each component (e.g., objects, colors in images, etc.) of the non-textual content may be displayed within the object in text format using various text expression methods such as alternative text, caption, annotation, metadata, tag, etc.

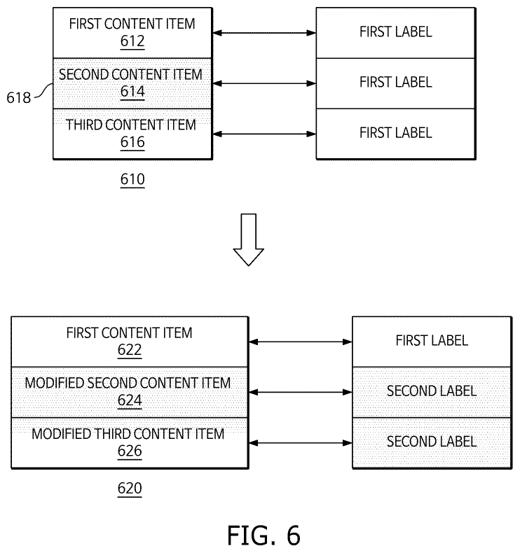

FIG. 6 is a diagram illustrating an example in which labels of content items 614 and 616 are modified in response to a specific part 618 of an AI-generated content 610 being modified to a user-generated content. The AI-generated content 610 may be divided into a plurality of content items 612, 614, and 616 according to a predetermined unit (e.g., morpheme unit, letter unit, word unit, sentence unit, and paragraph unit) and stored in the structured document. In this case, a label may be allocated to each of the plurality of content items 612, 614, and 616. For example, as illustrated in the drawing, a first label indicating AI-generated content may be allocated to each of the plurality of content items 612, 614, and 616.

In response to the specific part 618 of the AI-generated content 610 being modified by the user, the label allocated to each of the plurality of content items 612, 614, and 616 may be changed. In this case, the labels allocated to the content items 614 and 616 associated with the specific part 618 may be automatically deleted or modified. For example, in response to the specific part 618 including all of the second content item 614 and a part of the third content item 616 being modified, the labels allocated to a modified second content item 624 and a modified third content item 626 in a modified content 620 may be automatically modified to the second label indicating the user-generated content. That is, in the example illustrated and described above, the labels may be changed in units of pre-divided content items.

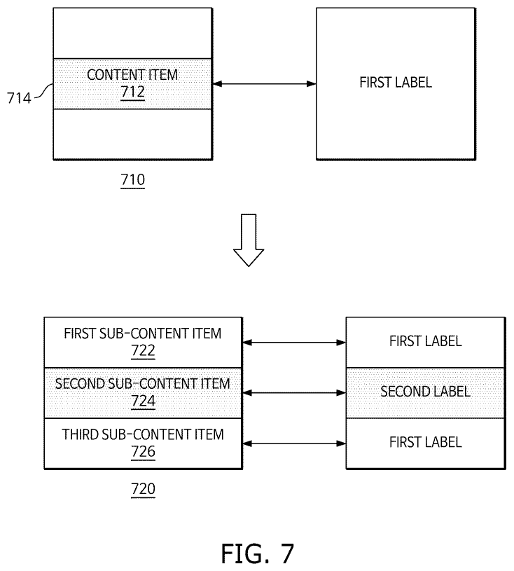

FIG. 7 is a diagram illustrating an example in which labels are allocated after a content item 712 is divided in response to a specific part 714 that is a part of the content item 712 being modified to a user-generated content. Although FIG. 7 illustrates that an AI-generated content 710 includes only one content item 712 for convenience of explanation, aspects are not limited thereto, and other content items may be further included.

In response to the specific part 714 that is part of the content item 712 in the AI-generated content 710 being modified by the user, the content item 712 may be divided into a second sub-content item 724 corresponding to the specific part 714, and a first sub-content item 722 and a third sub-content item 726 corresponding to other part than the specific part 714.

After the content item 712 is divided into the first sub-content item 722, the second sub-content item 724, and the third sub-content item 726, the first label (e.g., indicating the AI-generated content) allocated to the second sub-content item 724 corresponding to the specific part 714 of the modified content 720 may be automatically deleted, or the second label (e.g., indicating user-generated content) may be automatically allocated. That is, unlike the example of FIG. 6 in which the labels are changed in units of pre-divided content items, in the example illustrated and described in FIG. 7, the changed content part may be divided into sub-content items and converted into user-generated content. The first label (e.g., indicating the AI-generated content) may be maintained and allocated for the first sub-content item 722 and the third sub-content item 726 which are unmodified parts of the content item 712.

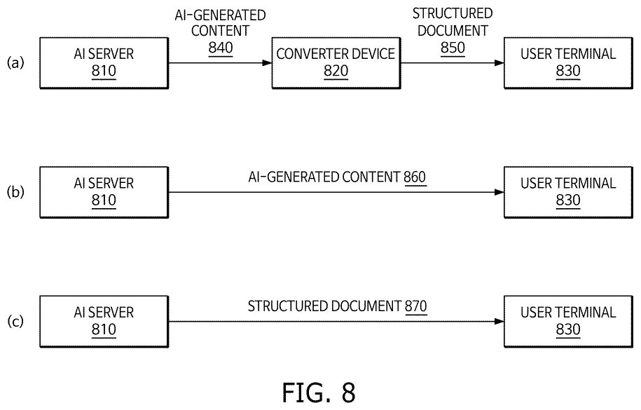

FIG. 8 is a diagram illustrating subjects that allocate labels. The label allocated to the AI-generated content (or content item) may be allocated through an external devices such as an AI server 810, a converter device 820 (or a converter server), or a user terminal 830 on which the AI content is displayed. As structured documents 850 and 870 are generated, the labels may be allocated to individual objects in the structured document 850.

As illustrated in FIG. 8(a), the AI server 810 may generate an AI-generated content 840 using a generative model. The AI server 810 may transmit the generated AI-generated content 840 to the separate converter device 820. The converter device 820 may allocate a label to the AI-generated content 840 to generate the structured document 850. The converter device 820 may transmit the structured document 850 to the user terminal 830.

In another aspect, as illustrated in FIG. 8(b), the AI server 810 may generate and transmit an AI-generated content 860 to the user terminal 830. The user terminal 830 may allocate a label to the AI-generated content 860 to generate a structured document.

In another aspect, as illustrated in FIG. 8(c), the AI server 810 may generate an AI-generated content and allocate a label to the AI-generated content to generate the structured document 870. The AI server 810 may transmit the structured document 870 to the user terminal 830.

Additionally, when the user modifies part of the AI-generated content, another label may be allocated or the existing label may be deleted by the user terminal 830, the AI server 810, or the converter device 820.

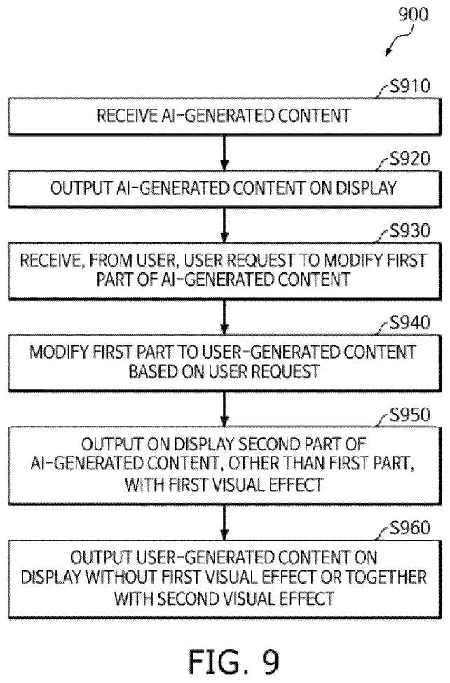

FIG. 9 is a flowchart provided to explain a method 900 for displaying an AI content. The method 900 may be performed by at least one processor 334 or 314 of the information processing system 230 or the user terminal 210. The method 900 may be initiated by the processor 334 or 314 receiving artificial intelligence (AI) generated content, at S910.

The processor may output the AI-generated content on the display of the user terminal 210, at S920. The first label may be automatically allocated to the AI-generated content, and in response to determining that the first label is allocated to the AI-generated content, the processor may output the AI-generated content together with the first visual effect on the display. In this case, the first label may be allocated by at least one processor or external device performing the method 900.

The AI-generated content may be divided into a plurality of content items according to a predetermined unit and stored in a structured document, and the first label may be automatically allocated to each content item. In this case, the predetermined unit may be one of a morpheme unit, a letter unit, a word unit, a sentence unit, and a paragraph unit.

The processor may receive a user request to modify the first part of the AI-generated content from the user, at S930, and modify the first part to the user-generated content based on the user request, at S940. The user-generated content is automatically allocated a particular label, and in response to determining that the user-generated content is allocated the particular label, the processor may output the user-generated content on the display of the user terminal 210 without the first visual effect or output the user-generated content on the display with a second visual effect that is different from the first visual effect.

The processor may output, on the display, the second part of the AI-generated content, other than the first part, together with the first visual effect, at S950.

Additionally, the processor may output the user-generated content on the display without the first visual effect or together with a second visual effect, different from the first visual effect, at S960. The AI-generated content may be automatically allocated the first label, and the user-generated content may be automatically allocated the second label. In response to determining that the user-generated content is allocated the second label, the processor may output the user-generated content on the display with the second visual effect and without the first visual effect, or output the user-generated content on the display with the second visual effect that is different from the first visual effect along with the first visual effect.

In response to the first part of the AI-generated content being modified to the user-generated content, the first label allocated to at least one content item associated with the first part in the structured document may be automatically deleted or modified to the second label. In another aspect, if the first part is part of a specific content item, the specific content item may be divided into a first sub-content item corresponding to the first part and a second sub-content item, and the first label allocated to the first sub-content item may be automatically deleted or modified to the second label.

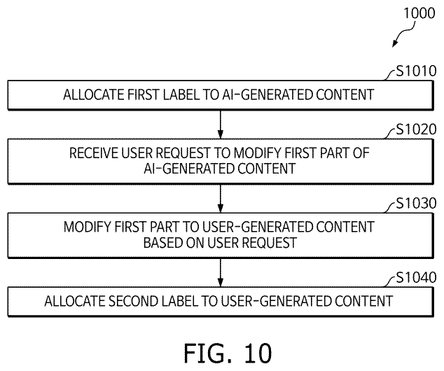

FIG. 10 is a flowchart illustrating a label dynamic control method 1000. The method 1000 may be performed by at least one processor 334 or 314 of the information processing system 230 or the user terminal 210. The method 1000 may be initiated by the processor 334 or 314 allocating the first label to the AI-generated content, at S1010. The AI-generated content may be divided into a plurality of content items according to a predetermined unit and stored in the structured document, and the first label may be allocated to each content item. In this case, the predetermined unit may be one of a morpheme unit, a letter unit, a word unit, a sentence unit, and a paragraph unit.

The processor 334 or 314 may receive a user request to modify the first part of the AI-generated content, at S1020, and the processor may modify the first part to the user-generated content based on the user request, at S1030. The second part of the AI-generated content, other than the first part, may be output together with the first visual effect, and the user-generated content may be output without the first visual effect or together with a second visual effect. The first visual effect and the second visual effect may be different from each other.

The processor may allocate the second label to user-generated content, at S1040.

The flowcharts illustrated in FIGS. 9 and 10 and the above description are merely examples, and may be implemented differently in some aspects. For example, one or more operations may be omitted, the order of operations may be changed, one or more operations may be performed in parallel, or one or more operations may be repeatedly performed multiple times.

The method described above may be provided as a computer program stored in a computer-readable recording medium for launch on a computer. The medium may be a type of medium that continuously stores a program executable by a computer, or temporarily stores the program for execution or download. In addition, the medium may be a variety of writing means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies according to design requirements imposed on the particular application and the overall system. Those skilled in the art may implement the described functions in varying ways for each particular application, but such implementation should not be interpreted as causing a departure from the scope of the present disclosure.

In a hardware implementation, processing units or processors used to perform the techniques may be implemented in one or more ASICs, DSPs, digital signal processing devices (DSPDs), programmable logic devices (PLDs), field programmable gate arrays (FPGAs), controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with processors, DSPs, ASICs, FPGAs or other programmable logic devices, discrete gate or transistor logic, discrete hardware components, or any combination of those designed to perform the functions described herein. A processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with commands stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The commands may be executable by one or more processors, and may cause the processor(s) to perform certain aspects of the functions described in the present disclosure.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some aspects herein, various modifications and changes can be made without departing from the scope of the present disclosure, which can be understood by those skilled in the art to which the present disclosure pertains. Additionally, such modifications and changes should be considered to fall within the scope of the claims appended hereto.

1. A method for displaying an artificial intelligence (AI) content executed by one or more processors and comprising:
receiving an AI-generated content;
outputting the AI-generated content on a display;
receiving, from a user, a user request to modify a first part of the AI-generated content;
modifying the first part to a user-generated content based on the user request; and
outputting a second part of the AI-generated content on the display with a first visual effect.

2. The method according to claim 1, further comprising outputting the user-generated content on the display without the first visual effect.

3. The method according to claim 1, further comprising outputting the user-generated content on the display with a second visual effect,
wherein the first visual effect and the second visual effect are different from each other.

4. The method according to claim 1, further comprising allocating a first label to the AI-generated content,
wherein, in response to determining that the first label is allocated to the AI-generated content, the AI-generated content is output on the display together with the first visual effect.

5. The method according to claim 1, further comprising:
allocating a first label to the AI-generated content, and
allocating a second label to the user-generated content,
wherein, in response to determining that the second label is allocated to the user-generated content, the user-generated content is output on the display without the first visual effect or together with a second visual effect, and
wherein the first visual effect and the second visual effect are different from each other.

6. The method according to claim 4, wherein the AI-generated content is divided into a plurality of content items according to a predetermined unit and stored in a structured document, and
the first label is allocated to each of the plurality of content items.

7. The method according to claim 6, wherein the predetermined unit is one of a morpheme unit, a letter unit, a word unit, a sentence unit or a paragraph unit.

8. The method according to claim 6, wherein, in response to the first part being modified to the user-generated content, the first label allocated to at least one content item associated with the first part in the structured document is deleted or modified to a second label.

9. The method according to claim 6, wherein, when the first part is apart of a specific content item, the specific content item is divided into a first sub-content item corresponding to the first part and a second sub-content item, and
the first label allocated to the first sub-content item is deleted or modified to a second label.

10. The method according to claim 1, further comprising allocating a specific label to the user-generated content,
wherein, in response to determining that the specific label is allocated to the user-generated content, the user-generated content is output on the display without the first visual effect or together with a second visual effect, and
wherein the first visual effect is different from the second visual effect.

11. The method according to claim 4, wherein the first label is allocated by the one or more processors or an external device.

12. A non-transitory computer-readable recording medium storing instructions that, when executed by one or more processors, cause the performance of the method according to claim 1.

13. An apparatus for displaying an artificial intelligence (AI) content, comprising:
a communication module;
a display;
a memory; and
one or more processors connected to the memory and configured to execute one or more computer-readable programs stored in the memory,
wherein the one or more programs include instructions for:
receiving an AI-generated content;
outputting the AI-generated content on the display,
receiving, from a user, a user request to modify a first part of the AI-generated content;
modifying the first part to a user-generated content based on the user request; and
outputting a second part of the AI-generated content on the display together with a first visual effect.

14. A label dynamic control method executed by one or more processors, comprising:
allocating a first label to an AI-generated content;
receiving a user request to modify a first part of the AI-generated content;
modifying the first part to a user-generated content based on the user request; and
allocating a second label to the user-generated content.

15. The method according to claim 14, wherein a second part of the AI-generated content is output together with a first visual effect, and
the user-generated content is output without the first visual effect or together with a second visual effect,
wherein the first visual effect and the second visual effect are different from each other.

16. The method according to claim 14, wherein the AI-generated content is divided into a plurality of content items according to a predetermined unit and stored in a structured document, and
the first label is allocated to each content item.

17. The method according to claim 16, wherein the predetermined unit is one of a morpheme unit, a letter unit, a word unit, a sentence unit or a paragraph unit.
